(19) United States
(12) Patent Application Publication
(10) Pub. No.: US 2026/0055518 A1
(43) Pub. Date: Feb. 26, 2026

(54) ELECTROCHEMICAL HYDROGEN PRODUCTION UTILIZING AMMONIA WITH OXIDANT INJECTION

(71) Applicant: Utility Global, Inc., Houston, TX (US)

(72) Inventors: Jason Dana, Woodlands, TX (US); Matthew Dawson, Katy, TX (US); Nicholas Farandos, Greystones (IE); Jin Dawson, Katy, TX (US)

(73) Assignee: Utility Global, Inc., Houston, TX (US)

(21) Appl. No.: 19/102,620

(22) PCT Filed: May 10, 2023
(86) PCT No.: PCT/US2023/021651

§ 371 Date: Feb. 10, 2025

Related U.S. Application Data
(60) Provisional application No. 63/397,144, filed on Aug. 11, 2022.

(51) Int. Cl. C25B 1/04; C25B 11/042; C25B 13/05; C25B 15/08

(52) U.S. Cl. CPC C25B 1/04; C25B 11/042; C25B 13/05; C25B 15/08

(57) ABSTRACT

Herein discussed is a method of producing hydrogen comprising: (a) providing an electrochemical reactor having an anode, a cathode, and a membrane between the anode and the cathode, wherein the membrane is both electronically conducting and ionically conducting; (b) introducing a first stream to the anode, wherein the first stream comprises ammonia; (c) introducing an oxidant to the anode; and (d) introducing a second stream to the cathode, wherein the second stream comprises water and provides a reducing environment for the cathode; wherein hydrogen is generated from water electrochemically; wherein the first stream and the second stream are separated by the membrane; and wherein the oxidant and the second stream are separated by the membrane.

### TECHNICAL FIELD

This invention generally relates to hydrogen production. More specifically, this invention relates to electrochemical hydrogen production using ammonia with oxidant injection.

### BACKGROUND

Hydrogen in large quantities is needed in the petroleum and chemical industries. For example, large amounts of hydrogen are used in upgrading fossil fuels and in the production of methanol or hydrochloric acid. Petrochemical plants need hydrogen for hydrocracking, hydrodesulfurization, hydrodealkylation. Hydrogenation processes to increase the level of saturation of unsaturated fats and oils also need hydrogen. Hydrogen is also a reducing agent of metallic ores. Hydrogen may be produced from electrolysis of water, steam reforming, lab-scale metal-acid process, thermochemical methods, or anaerobic corrosion. Many countries are aiming at a hydrogen economy, which requires transportation of large quantities of hydrogen. Ammonia has been identified as a suitable surrogate molecule for hydrogen transport as it is comparatively easy to contain and transmit compared to either pressurized or liquified hydrogen. However, ammonia by itself is not easily utilized and must be transformed to hydrogen. This transformation process unfortunately produces hydrogen mixed with nitrogen and these two gases are difficult to separate easily, efficiently, or economically. To be useful in conventional systems and processes, the hydrogen must be separated from the nitrogen.

Clearly there is increasing need and interest to develop new technological platforms to produce hydrogen. This disclosure discusses hydrogen production utilizing ammonia via efficient electrochemical pathways. The electrochemical reactor and the method to perform such reactions are discussed.

### SUMMARY

Herein discussed is a method of producing hydrogen comprising: (a) providing an electrochemical reactor having an anode, a cathode, and a membrane between the anode and the cathode, wherein the membrane is both electronically conducting and ionically conducting; (b) introducing a first stream to the anode, wherein the first stream comprises ammonia; (c) introducing an oxidant to the anode; and (d) introducing a second stream to the cathode, wherein the second stream comprises water and provides a reducing environment for the cathode; wherein hydrogen is generated from water electrochemically; wherein the first stream and the second stream are separated by the membrane; and wherein the oxidant and the second stream are separated by the membrane.

In an embodiment, the oxidant comprises oxygen or air. In an embodiment, the mole ratio of ammonia to oxygen on the anode side is no less than 2, or no less than 3, or no less than 4. In an embodiment, ammonia cracking takes place in situ at the anode. In an embodiment, the second stream comprises hydrogen. In an embodiment, the method comprises introducing a hydrocarbon to the anode. In an embodiment, the oxidant is added to the anode at multiple points along the first stream flow path.

In an embodiment, the anode comprises Ni or NiO and a material selected from the group consisting of YSZ, CGO, SDC, SSZ, LSGM. In an embodiment, the cathode comprises Ni or NiO and a material selected from the group consisting of YSZ, CGO, SDC, SSZ, LSGM, and combinations thereof. In an embodiment, the membrane comprises CoCGO or LST (lanthanum-doped strontium titanate)-stabilized zirconia. In an embodiment, LST comprises LCST (lanthanum-and-calcium-doped strontium titanate). In an embodiment, the stabilized zirconia comprises YSZ or SSZ or SCZ (scandia-ceria-stabilized zirconia).

In an embodiment, the membrane comprises an electronically conducting phase containing doped lanthanum chromite or an electronically conductive metal or combination thereof; and wherein the membrane comprises an ionically conducting phase containing a material selected from the group consisting of gadolinium doped ceria (CGO), samarium doped ceria (SDC), yttria-stabilized zirconia (YSZ), lanthanum strontium gallate magnesite (LSGM), scandia-stabilized zirconia (SSZ), Sc and Ce doped zirconia, and combinations thereof. In an embodiment, the doped lanthanum chromite comprises strontium doped lanthanum chromite, iron doped lanthanum chromite, strontium and iron doped lanthanum chromite, lanthanum calcium chromite, or combinations thereof. In an embodiment, the conductive metal comprises Ni, Cu, Ag, Au, Pt, Rh, Co, Ru, or combinations thereof.

Also discussed herein is a hydrogen production system comprising an ammonia source, an oxidant source, and an electrochemical (EC) reactor comprising an anode, a cathode, and a membrane between the anode and the cathode, wherein the membrane is both electronically conducting and ionically conducting, wherein the EC reactor is configured to receive a first stream from the ammonia source and an oxidant from the oxidant source on the anode side, wherein the EC reactor is configured to receive a second stream on the cathode side, wherein the second stream comprises water and provides a reducing environment for the cathode.

In an embodiment, the anode comprises Ni or NiO and a material selected from the group consisting of YSZ, CGO, SDC, SSZ, LSGM. In an embodiment, the cathode comprises Ni or NiO and a material selected from the group consisting of YSZ, CGO, SDC, SSZ, LSGM, and combinations thereof. In an embodiment, the membrane comprises CoCGO or LST (lanthanum-doped strontium titanate)-stabilized zirconia. In an embodiment, LST comprises LCST (lanthanum-and-calcium-doped strontium titanate). In an embodiment, the stabilized zirconia comprises YSZ or SSZ or SCZ (scandia-ceria-stabilized zirconia).

In an embodiment, the second stream comprises hydrogen. In an embodiment, the mole ratio of ammonia to oxidant on the anode side is no less than 2, or no less than 3, or no less than 4. In an embodiment, the anode is configured to receive a hydrocarbon. In an embodiment, the system comprises a multi-position injection port in fluid communication with the reactor, wherein the multi-position injection port is configured to introduce to the anode the oxidant, the hydrocarbon, or both. In an embodiment, the cathode is configured to generate hydrogen from water electrochemically. In an embodiment, the reactor comprises no interconnect and no current collector.

In an embodiment, the membrane comprises an electronically conducting phase containing doped lanthanum chromite or an electronically conductive metal or combination thereof; and wherein the membrane comprises an ionically conducting phase containing a material selected from the group consisting of gadolinium doped ceria (CGO), samarium doped ceria (SDC), yttria-stabilized zirconia (YSZ), lanthanum strontium gallate magnesite (LSGM), scandia-stabilized zirconia (SSZ), Sc and Ce doped zirconia, and combinations thereof. In an embodiment, the doped lanthanum chromite comprises strontium doped lanthanum chromite, iron doped lanthanum chromite, strontium and iron doped lanthanum chromite, lanthanum calcium chromite, or combinations thereof; and wherein the conductive metal comprises Ni, Cu, Ag, Au, Pt, Rh, Co, Ru, or combinations thereof.

Further aspects and embodiments are provided in the following drawings, detailed description, and claims. Unless specified otherwise, the features as described herein are combinable and all such combinations are within the scope of this disclosure.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 illustrates an electrochemical (EC) reactor or an electrochemical gas producer, according to an embodiment of this disclosure.

FIG. 2A illustrates a tubular electrochemical reactor, according to an embodiment of this disclosure.

FIG. 2B illustrates a cross section of a tubular electrochemical reactor, according to an embodiment of this disclosure.

FIG. 3A illustrates a process and system of producing hydrogen electrochemically using ammonia, according to an embodiment of this disclosure.

FIG. 3B illustrates an alternative process and system of producing hydrogen electrochemically using ammonia, according to an embodiment of this disclosure.

### DETAILED DESCRIPTION

### Overview

Ammonia is an abundant and common chemical shipped around the globe. Furthermore, ammonia (unlike hydrogen) does not need to be stored under high pressure or cryogenically; and ammonia has ten times the energy density of a lithium-ion battery. As such, utilizing ammonia to produce hydrogen is very advantageous if it is done efficiently and economically. The disclosure herein discusses electrochemical systems and methods that are suitable for producing hydrogen using ammonia.

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like. As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, compositions and materials are used interchangeably unless otherwise specified. Each composition/material may have multiple elements, phases, and components. Heating as used herein refers to actively adding energy to the compositions or materials.

As used herein, YSZ refers to yttria-stabilized zirconia; SDC refers to samaria-doped ceria; SSZ refers to scandia-stabilized zirconia; LSGM refers to lanthanum strontium gallate magnesite.

In this disclosure, no substantial amount of H₂ means that the volume content of the hydrogen is no greater than 5%, or no greater than 3%, or no greater than 2%, or no greater than 1%, or no greater than 0.5%, or no greater than 0.1%, or no greater than 0.05%.

As used herein, CGO refers to Gadolinium-Doped Ceria, also known alternatively as gadolinia-doped ceria, gadolinium-doped cerium oxide, cerium (IV) oxide, gadolinium-doped, GDC, or GCO, (formula Gd:CeO₂). CGO and GDC are used interchangeably unless otherwise specified. Syngas (i.e., synthesis gas) in this disclosure refers to a mixture consisting primarily of hydrogen, carbon monoxide and carbon dioxide.

A mixed conducting membrane is able to transport both electrons and ions. Ionic conductivity includes ionic species such as oxygen ions (or oxide ions), protons, halogenide anions, chalcogenide anions. In various embodiment, the mixed conducting membrane of this disclosure comprises an electronically conducting phase and an ionically conducting phase.

In this disclosure, the axial cross section of the tubulars is shown to be circular, which is illustrative only and not limiting. The axial cross section of the tubulars is any suitable shape as known to one skilled in the art, such as square, square with rounded corners, rectangle, rectangle with rounded corners, triangle, hexagon, pentagon, oval, irregular shape, etc.

As used herein, ceria refers to cerium oxide, also known as ceric oxide, ceric dioxide, or cerium dioxide, is an oxide of the rare-earth metal cerium. Doped ceria refers to ceria doped with other elements, such as samaria-doped ceria (SDC), or gadolinium-doped ceria (GDC or CGO). As used herein, chromite refers to chromium oxides, which includes all the oxidation states of chromium oxides.

A layer or substance being impermeable as used herein refers to it being impermeable to fluid flow. For example, an impermeable layer or substance has a permeability of less than 1 micro darcy, or less than 1 nano darcy.

In this disclosure, sintering refers to a process to form a solid mass of material by heat or pressure, or a combination thereof, without melting the material to the extent of liquefaction. For example, material particles are coalesced into a solid or porous mass by being heated, wherein atoms in the material particles diffuse across the boundaries of the particles, causing the particles to fuse together and form one solid piece.

The term “in situ” in this disclosure refers to the treatment (e.g., heating or cracking) process being performed either at the same location or in the same device. For example, ammonia cracking taking place in the electrochemical reactor at the anode is considered in situ.

Electrochemistry is the branch of physical chemistry concerned with the relationship between electrical potential, as a measurable and quantitative phenomenon, and identifiable chemical change, with either electrical potential as an outcome of a particular chemical change, or vice versa. These reactions involve electrons moving between electrodes via an electronically-conducting phase (typically, but not necessarily, an external electrical circuit), separated by an ionically-conducting and electronically insulating membrane (or ionic species in a solution). When a chemical reaction is effected by a potential difference, as in electrolysis, or if electrical potential results from a chemical reaction as in a battery or fuel cell, it is called an electrochemical reaction. Unlike chemical reactions, in electrochemical reactions electrons (and necessarily resulting ions), are not transferred directly between molecules, but via the aforementioned electronically conducting and ionically conducting circuits, respectively. This phenomenon is what distinguishes an electrochemical reaction from a chemical reaction.

Related to the electrochemical reactor and methods of use, various components of the reactor are described such as electrodes and membranes along with materials of construction of the components. The following description recites various aspects and embodiments of the inventions disclosed herein. No particular embodiment is intended to define the scope of the invention. Rather, the embodiments provide non-limiting examples of various compositions and methods that are included within the scope of the claimed inventions. The description is to be read from the perspective of one of ordinary skill in the art. Therefore, information that is well-known to the ordinarily skilled artisan is not necessarily included.

An interconnect in an electrochemical device (e.g., a fuel cell) is often either metallic or ceramic that is placed between the individual cells or repeat units. Its purpose is to connect each cell or repeat unit so that electricity can be distributed or combined. An interconnect is also referred to as a bipolar plate in an electrochemical device. An interconnect being an impermeable layer as used herein refers to it being a layer that is impermeable to fluid flow.

### Electrochemical Reactor

Contrary to conventional practice, an electrochemical reactor has been discovered, which comprises an ionically conducting membrane, wherein the reactor is capable of reforming a hydrocarbon electrochemically or of performing water gas shift reactions electrochemically. The electrochemical reforming reactions involve the exchange of an ion through the membrane to oxidize the hydrocarbon. The electrochemical reactions involve the exchange of an ion through the membrane and include forward water gas shift reactions, or reverse water gas shift reactions, or both. These are different from traditional reforming reactions and water gas shift reactions via chemical pathways because they involve direct combination of reactants.

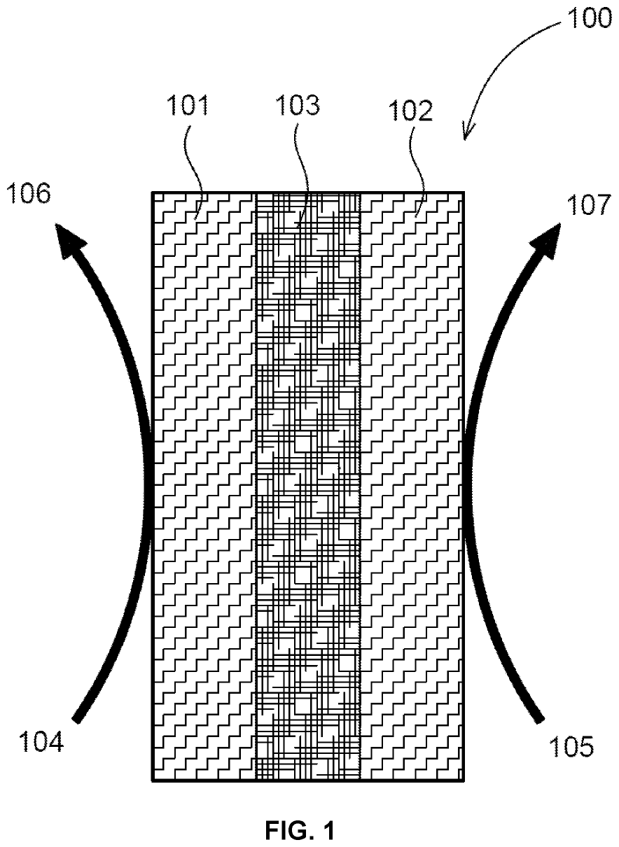

FIG. 1 illustrates an electrochemical reactor or an electrochemical (EC) gas producer 100, according to an embodiment of this disclosure. electrochemical reactor (or EC gas producer) device 100 comprises first electrode 101, membrane 103 a second electrode 102. First electrode 101 (also referred to as anode or bi-functional layer) is configured to receive a fuel 104. Stream 104 contains no oxygen. Second electrode 102 is configured to receive water (e.g., steam) as denoted by 105.

In an embodiment, device 100 is configured to receive CO or H₂ (104) and to generate CO/CO₂ or H₂O (106) at the first electrode (101); device 100 is also configured to receive water or steam (105) and to generate hydrogen (107) at the second electrode (102). In some cases, the second electrode receives a mixture of steam and hydrogen. Since water provides the oxide ion (which is transported through the membrane) needed to oxidize the CO or H₂ at the opposite electrode, water is considered the oxidant in this scenario. As such, the first electrode 101 is performing oxidation reactions in a reducing environment. In various embodiments, 103 represents an oxide ion conducting membrane. In an embodiment, the first electrode 101 and the second electrode 102 comprise Ni-YSZ or NiO-YSZ. In an embodiment, the oxide ion conducting membrane 103 also conducts electrons. In these cases, gases containing H₂, CO, syngas, or combinations thereof are suitable as feed stream 104. In various embodiments, electrodes 101 and 102 comprise Ni or NiO and a material selected from the group consisting of YSZ, CGO, SDC, SSZ, LSGM, and combinations thereof. Alternatively, gases containing a hydrocarbon are reformed before coming into contact with the membrane 103/electrode 101. The reformer is configured to perform steam reforming, dry reforming, or combination thereof. The reformed gases are suitable as feed stream 104.

In an embodiment, device 100 is configured to simultaneously produce hydrogen 107 from the second electrode 102 and syngas 106 from the first electrode 101. In an embodiment, 104 represents methane and water or methane and carbon dioxide entering device 100. In another embodiment, 104 represents methane. In other embodiments, 103 represents an oxide ion conducting membrane. Arrow 104 represents an influx of hydrocarbon and water or hydrocarbon and carbon dioxide. Arrow 105 represents an influx of water or water and hydrogen. In some embodiments, electrode 101 comprises Cu-CGO, or further optionally comprises CuO or Cu₂O or combination thereof; electrode 102 comprises Ni-YSZ or NiO-YSZ. In some cases, electrode 101 comprises doped or undoped ceria and a material selected from the group consisting of Cu, CuO, Cu₂O, Ag, Ag₂O, Au, Au₂O, Au₂O₃, Pt, Pd, Ru, Rh, Ir, LaCaCr, LaSrCrFe, YSZ, CGO, SDC, SSZ, LSGM, stainless steel, and combinations thereof; and electrode 102 comprises Ni or NiO and a material selected from the group consisting of YSZ, CGO, SDC, SSZ, LSGM, and combinations thereof. In some cases, electrode 101 comprises lanthanum chromite and a material selected from the group consisting of doped ceria, yttria-stabilized zirconia (YSZ), lanthanum strontium gallate magnesite (LSGM), scandia-stabilized zirconia (SSZ), Sc and Ce doped zirconia, and combinations thereof; electrode 102 comprises Ni or NiO and a material selected from the group consisting of YSZ, CGO, SDC, SSZ, LSGM, and combinations thereof. In various embodiments, the lanthanum chromite comprises undoped lanthanum chromite, strontium doped lanthanum chromite, iron doped lanthanum chromite, strontium and iron doped lanthanum chromite, lanthanum calcium chromite, or combinations thereof.

Arrow 104 represents an influx of hydrocarbon with little to no water, with no carbon dioxide, and with no oxygen, and 105 represents an influx of water or water and hydrogen. Since water provides the oxide ion (which is transported through the membrane) needed to oxidize the hydrocarbon/fuel at the opposite electrode, water is considered the oxidant in this scenario. In these cases, gases containing a hydrocarbon are suitable as feed stream 104 and reforming of the gases is not necessary. In these cases, electrochemical reforming is enabled by the reactor, where the oxygen needed to reform the methane derives from the reduction of water, and it is supplied across the membrane. The half-cell reactions are electrochemical and are as follows:

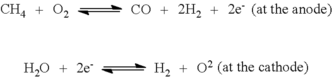

In this disclosure, no oxygen means there is no oxygen present at first electrode 101 or at least not enough oxygen that would interfere with the reaction. Also, in this disclosure, water only means that the intended feedstock is water and does not exclude trace elements or inherent components in water. For example, water containing salts or ions is considered to be within the scope of water only. Water only also does not require 100% pure water but includes this embodiment. In embodiments, the hydrogen produced from second electrode 102 is pure hydrogen, which means that in the produced gas phase from the second electrode, hydrogen is the main component. In some cases, the hydrogen content is no less than 99.5%. In some cases, the hydrogen content is no less than 99.9%. In some cases, the hydrogen produced from the second electrode is the same purity as that produced from electrolysis of water.

In an embodiment, first electrode 101 is configured to receive methane or methane and water or methane and carbon dioxide. In an embodiment, the fuel comprises a hydrocarbon having a carbon number in the range of 1-12, 1-10 or 1-8. Most preferably, the fuel is methane or natural gas, which is predominantly methane. In an embodiment, the device does not generate electricity and is not a fuel cell.

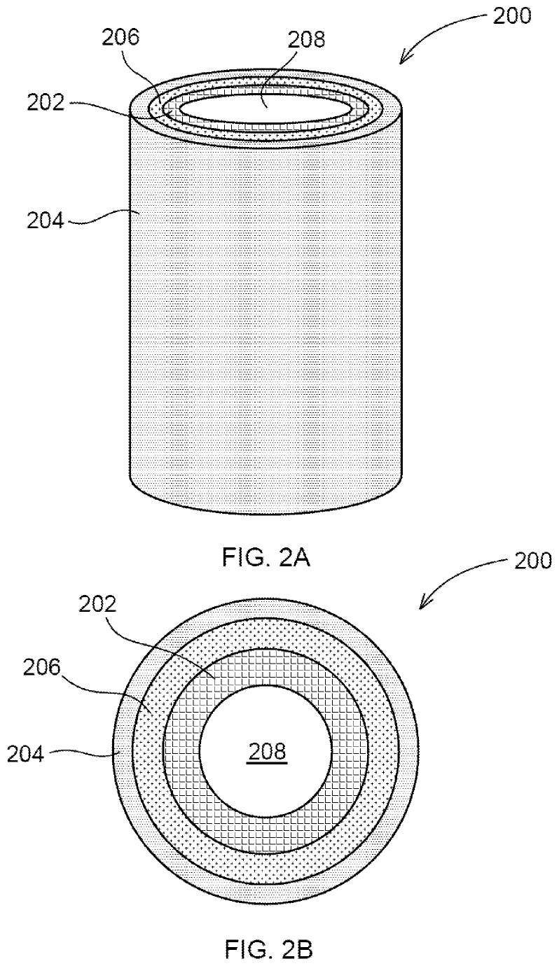

In various embodiments, the device does not contain a current collector. In an embodiment, the device comprises no interconnect. There is no need for electricity and such a device is not an electrolyzer. This is a major advantage of the EC reactor of this disclosure. The membrane 103 is configured to conduct electrons and as such is mixed conducting, i.e., both electronically conductive and ionically conductive. In an embodiment, the membrane 103 conducts oxide ions and electrons. In an embodiment, the electrodes 101, 102 and the membrane 103 are tubular (see, e.g., FIGS. 2A and 2B). In an embodiment, the electrodes 101, 102 and the membrane 103 are planar. In these embodiments, the electrochemical reactions at the anode and the cathode are spontaneous without the need to apply potential/electricity to the reactor.

In an embodiment, the electrochemical reactor (or EC gas producer) is a device comprising a first electrode, a second electrode, and a membrane between the electrodes, wherein the first electrode and the second electrode comprise a metallic phase that does not contain a platinum group metal when the device is in use, and wherein the membrane is oxide ion conducting. In an embodiment, the first electrode is configured to receive a fuel. In an embodiment, said fuel comprises a hydrocarbon or hydrogen or carbon monoxide or combinations thereof. In an embodiment, the second electrode is configured to receive water and hydrogen and configured to reduce the water to hydrogen. In various embodiments, such reduction takes place electrochemically.

In an embodiment, the membrane comprises an electronically conducting phase containing doped lanthanum chromite or an electronically conductive metal or combination thereof; and wherein the membrane comprises an ionically conducting phase containing a material selected from the group consisting of gadolinium doped ceria (CGO), samarium doped ceria (SDC), yttria-stabilized zirconia (YSZ), lanthanum strontium gallate magnesite (LSGM), scandia-stabilized zirconia (SSZ), Sc and Ce doped zirconia, and combinations thereof. In an embodiment, the doped lanthanum chromite comprises strontium doped lanthanum chromite, iron doped lanthanum chromite, strontium and iron doped lanthanum chromite, lanthanum calcium chromite, or combinations thereof; and wherein the conductive metal comprises Ni, Cu, Ag, Au, Pt, Rh, Co, Ru, or combinations thereof. In an embodiment, the membrane comprises gadolinium doped ceria (CGO) or samarium doped ceria (SDC). In an embodiment, the membrane consists of gadolinium doped ceria (CGO) or samarium doped ceria (SDC).

In some cases, the membrane comprises a single phase that is mixed conducting-ionically conducting and electronically conducting. In an embodiment, the membrane comprises cobalt-CGO (CoCGO), i.e., cobalt doped CGO. In an embodiment, the membrane consists essentially of CoCGO. In an embodiment, the membrane consists of CoCGO.

In an embodiment, the membrane comprises LST (lanthanum-doped strontium titanate)-YSZ or LST-SSZ or LST-SCZ (scandia-ceria-stabilized zirconia). In various embodiments, LST comprises LCST (lanthanum and calcium-doped strontium titanate). In an embodiment, the membrane consists essentially of LST-YSZ or LST-SSZ or LST-SCZ. In an embodiment, the membrane consists of LST-YSZ or LST-SSZ or LST-SCZ. In this disclosure, LST-YSZ refers to a composite of LST and YSZ. In various embodiments, the LST phase and the YSZ phase percolate each other. In this disclosure, LST-SSZ refers to a composite of LST and SSZ. In various embodiments, the LST phase and the SSZ phase percolate each other. In this disclosure, LST-SCZ refers to a composite of LST and SCZ. In various embodiments, the LST phase and the SCZ phase percolate each other. YSZ, SSZ, and SCZ are types of stabilized zirconia's. In an embodiment, the membrane comprises CoCGO or LST (lanthanum-doped strontium titanate)-stabilized zirconia. In an embodiment, the stabilized zirconia comprises YSZ or SSZ or SCZ (scandia-ceria-stabilized zirconia).

FIG. 2A illustrates (not to scale) a tubular electrochemical (EC) reactor or an EC gas producer 200, according to an embodiment of this disclosure. Tubular producer 200 includes an inner tubular structure 202, an outer tubular structure 204, and a membrane 206 disposed between the inner and outer tubular structures 202, 204, respectively. Tubular producer 200 further includes a void space 208 for fluid passage. FIG. 2B illustrates (not to scale) a cross section of a tubular producer 200, according to an embodiment of this disclosure. Tubular producer 200 includes a first inner tubular structure 202, a second outer tubular structure 204, and a membrane 206 between the inner and outer tubular structures 202, 204. Tubular producer 200 further includes a void space 208 for fluid passage.

In an embodiment, the electrodes and the membrane are tubular with the first electrode being outermost and the second electrode being innermost, wherein the second electrode is configured to receive water and hydrogen. In an embodiment, the electrodes and the membrane are tubular with the first electrode being innermost and the second electrode being outermost, wherein the second electrode is configured to receive water and hydrogen. In an embodiment, the electrodes and the membrane are tubular.

### Hydrogen Production Using Ammonia

The EC reactor as discussed above is suitable to produce hydrogen from ammonia. A product from ammonia cracking comprises hydrogen and nitrogen and is sent to the anode of the EC reactor directly as the feed stream. In an embodiment, the reactor comprises porous electrodes that comprise metallic phase and ceramic phase, wherein the metallic phase is electronically conductive and wherein the ceramic phase is ionically conductive. In various embodiments, the electrodes have no current collector attached to them. In various embodiments, the reactor does not contain any current collector. Clearly, such a reactor is fundamentally different from any electrolysis device or fuel cell.

In an embodiment, one of the electrodes in the reactor is an anode that is configured to be exposed to a reducing environment while performing oxidation reactions electrochemically. In various embodiments, the electrodes comprise Ni or NiO and a material selected from the group consisting of YSZ, CGO, SDC, SSZ, LSGM, and combinations thereof.

The electrochemical reactions taking place in the reactor comprise electrochemical half-cell reactions, wherein the half-cell reactions are:

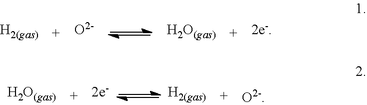

In various embodiments, the half-cell reactions take place at triple phase boundaries, wherein the triple phase boundaries are the intersections of pores with the electronically conducting phase and the ionically conducting phase. Furthermore, the reactor is also capable of performing chemical water gas shift reactions. In various embodiments, the ammonia cracking product comprises hydrogen and nitrogen, wherein the hydrogen is a suitable fuel for the anode of the EC reactor. An advantage of this method and system is that the presence of nitrogen does not affect the performance of the EC reactor and the production of hydrogen on the cathode side.

In various embodiments, the ionically conducting membrane conducts protons or oxide ions. In various embodiments, the ionically conducting membrane comprises solid oxide. In various embodiments, the ionically conducting membrane is impermeable to fluid flow. In various embodiments, the ionically conducting membrane also conducts electrons and wherein the reactor comprises no interconnect.

In an embodiment, the membrane comprises an electronically conducting phase containing doped lanthanum chromite or an electronically conductive metal or combination thereof; and wherein the membrane comprises an ionically conducting phase containing a material selected from the group consisting of gadolinium doped ceria (CGO), samarium doped ceria (SDC), yttria-stabilized zirconia (YSZ), lanthanum strontium gallate magnesite (LSGM), scandia-stabilized zirconia (SSZ), Sc and Ce doped zirconia, and combinations thereof. In an embodiment, the doped lanthanum chromite comprises strontium doped lanthanum chromite, iron doped lanthanum chromite, strontium and iron doped lanthanum chromite, lanthanum calcium chromite, or combinations thereof; and wherein the conductive metal comprises Ni, Cu, Ag, Au, Pt, Rh, Co, Ru, or combinations thereof. In an embodiment, the membrane comprises gadolinium doped ceria (CGO) or samarium doped ceria (SDC). In an embodiment, the membrane consists of gadolinium doped ceria (CGO) or samarium doped ceria (SDC).

In some cases, the membrane comprises a single phase that is mixed conducting-ionically conducting and electronically conducting. In an embodiment, the membrane comprises cobalt-CGO (CoCGO), i.e., cobalt doped CGO. In an embodiment, the membrane consists essentially of CoCGO. In an embodiment, the membrane consists of CoCGO.

In an embodiment, the membrane comprises LST (lanthanum-doped strontium titanate)-YSZ or LST-SSZ or LST-SCZ (scandia-ceria-stabilized zirconia). In various embodiments, LST comprises LCST (lanthanum and calcium-doped strontium titanate). In an embodiment, the membrane consists essentially of LST-YSZ or LST-SSZ or LST-SCZ. In an embodiment, the membrane consists of LST-YSZ or LST-SSZ or LST-SCZ. In this disclosure, LST-YSZ refers to a composite of LST and YSZ. In various embodiments, the LST phase and the YSZ phase percolate each other. In this disclosure, LST-SSZ refers to a composite of LST and SSZ. In various embodiments, the LST phase and the SSZ phase percolate each other. In this disclosure, LST-SCZ refers to a composite of LST and SCZ. In various embodiments, the LST phase and the SCZ phase percolate each other. YSZ, SSZ, and SCZ are types of stabilized zirconia's. In an embodiment, the membrane comprises CoCGO or LST (lanthanum-doped strontium titanate)-stabilized zirconia. In an embodiment, the stabilized zirconia comprises YSZ or SSZ or SCZ (scandia-ceria-stabilized zirconia).

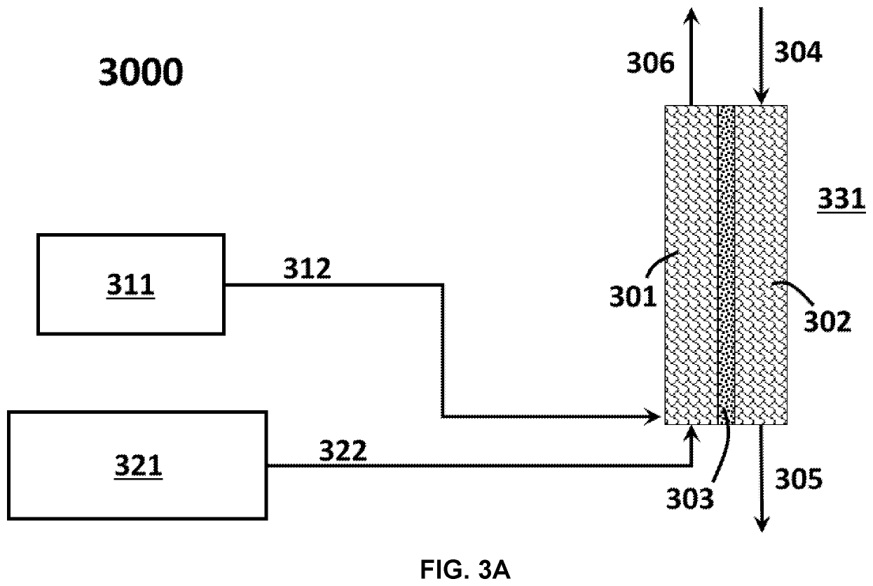

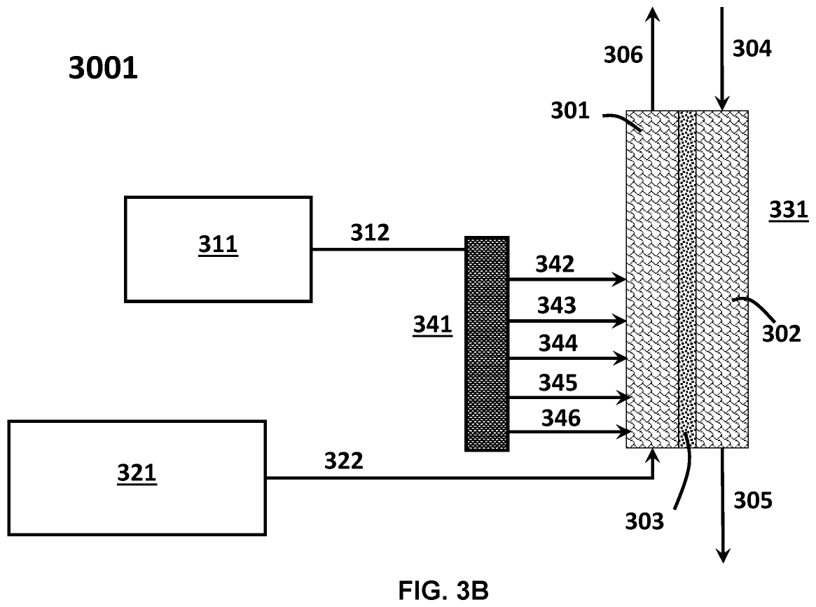

As illustrated in FIG. 3A, a hydrogen production system 3000 utilizing ammonia is shown. System 3000 comprises an EC reactor 331, an ammonia source 321, and an oxidant source 311. The EC reactor comprises anode 301, cathode 302, and a membrane 303 between the anode and the cathode. In various embodiments, the membrane 303 is mixed conducting. An ammonia stream 322 from the ammonia source 321 is sent to the anode 301 of the EC reactor 331. Oxidant source 311 provides oxygen or air (stream 312) to the anode 301 of reactor 331. The mole ratio of ammonia to oxygen on the anode side is no less than 2 or 3 or 4. The anode exhaust is extracted as stream 306. The cathode of 302 of EC reactor 331 is configured to receive water/steam 304 and to generate hydrogen (stream 305). Hydrogen is produced electrochemically by reducing water at the cathode. In some cases, stream 304 also comprises hydrogen. The atmosphere on the cathode side is a reducing environment.

Ammonia is partially oxidized on the anode side, which provides heat for ammonia cracking in situ. The resultant gas is suitable for use in the anode without the need to separate the inert gases (e.g., nitrogen, water/steam) from the hydrogen. These inert gases do not significantly affect the kinetics or thermodynamics of the electrochemical reactions that produce hydrogen on the cathode side. This is a unique advantage of using the EC reactor of this disclosure. In various cases, a hydrocarbon (e.g., methane) is added (not shown in FIG. 3A) to the anode 301 to be oxidized to generate additional heat for ammonia cracking and/or for the reactor. Carbon dioxide as an oxidized product also does not significantly affect the kinetics or thermodynamics of the electrochemical reactions.

As illustrated in FIG. 3B, an alternative hydrogen production system 3001 utilizing ammonia is shown. A multi-position injection port 341 is added between the oxidant source 311 and the EC reactor 331. The oxidant stream 312 through the injection port 341 is introduced into the reactor 331 on the anode (301) side as streams 342-346. The injection port allows the oxidant to be added along the flow path of the anode feed stream so that the oxidation reactions are more precisely controlled to provide the necessary heat for the reactor and/or for ammonia cracking. A hydrocarbon (e.g., methane) may also be added (not shown in FIG. 3B) to the anode 301 via the injection port to be oxidized to generate additional heat for ammonia cracking and/or for the reactor.

It is to be understood that this disclosure describes exemplary embodiments for implementing different features, structures, or functions of the invention. Exemplary embodiments of components, arrangements, and configurations are described to simplify the present disclosure; however, these exemplary embodiments are provided merely as examples and are not intended to limit the scope of the invention. The embodiments as presented herein may be combined unless otherwise specified. Such combinations do not depart from the scope of the disclosure.

Additionally, certain terms are used throughout the description and claims to refer to particular components or steps. As one skilled in the art appreciates, various entities may refer to the same component or process step by different names, and as such, the naming convention for the elements described herein is not intended to limit the scope of the invention. Further, the terms and naming convention used herein are not intended to distinguish between components, features, and/or steps that differ in name but not in function.

While the disclosure is susceptible to various modifications and alternative forms, specific embodiments thereof are shown by way of example in the drawings and description. It should be understood, however, that the drawings and detailed description are not intended to limit the disclosure to the particular form disclosed, but on the contrary, the intention is to cover all modifications, equivalents and alternatives falling within the spirit and scope of this disclosure.

1. A method of producing hydrogen comprising:
(a) providing an electrochemical reactor having an anode, a cathode, and a membrane between the anode and the cathode, wherein the membrane is both electronically conducting and ionically conducting;
(b) introducing a first stream to the anode, wherein the first stream comprises ammonia;
(c) introducing an oxidant to the anode; and
(d) introducing a second stream to the cathode, wherein the second stream comprises water and provides a reducing environment for the cathode;
(e) wherein hydrogen is generated from water electrochemically;
(f) wherein the first stream and the second stream are separated by the membrane; and
(g) wherein the oxidant and the second stream are separated by the membrane.

2. The method of claim 1, wherein the oxidant comprises oxygen or air.

3. The method of claim 1, wherein the mole ratio of ammonia to oxygen on the anode side is no less than 2, or no less than 3, or no less than 4.

4. The method of claim 1, wherein ammonia cracking takes place in situ at the anode.

5. The method of claim 1, wherein the second stream comprises hydrogen.

6. The method of claim 1 comprising introducing a hydrocarbon to the anode.

7. The method of claim 1, wherein the oxidant is added to the anode at multiple points along the first stream flow path.

8. The method of claim 1, wherein the anode comprises Ni or NiO and a material selected from the group consisting of YSZ, CGO, SDC, SSZ, LSGM, and wherein the cathode comprises Ni or NiO and a material selected from the group consisting of YSZ, CGO, SDC, SSZ, LSGM, and combinations thereof.

9. The method of claim 1, wherein the membrane comprises CoCGO or LST (lanthanum-doped strontium titanate)-stabilized zirconia, wherein optionally LST comprises LCST (lanthanum-and-calcium-doped strontium titanate), wherein optionally the stabilized zirconia comprises YSZ or SSZ or SCZ (scandia-ceria-stabilized zirconia).

10. (canceled)

11. The method of claim 1, wherein the membrane comprises an electronically conducting phase containing doped lanthanum chromite or an electronically conductive metal or combination thereof; and wherein the membrane comprises an ionically conducting phase containing a material selected from the group consisting of gadolinium doped ceria (CGO), samarium doped ceria (SDC), yttria-stabilized zirconia (YSZ), lanthanum strontium gallate magnesite (LSGM), scandia-stabilized zirconia (SSZ), Sc and Ce doped zirconia, and combinations thereof; wherein optionally the doped lanthanum chromite comprises strontium doped lanthanum chromite, iron doped lanthanum chromite, strontium and iron doped lanthanum chromite, lanthanum calcium chromite, or combinations thereof; and wherein optionally the conductive metal comprises Ni, Cu, Ag, Au, Pt, Rh, Co, Ru, or combinations thereof.

12. A hydrogen production system comprising
an ammonia source, an oxidant source, and
an electrochemical (EC) reactor comprising an anode, a cathode, and a membrane between the anode and the cathode, wherein the membrane is both electronically conducting and ionically conducting,
wherein the EC reactor is configured to receive a first stream from the ammonia source and an oxidant from the oxidant source on the anode side,
wherein the EC reactor is configured to receive a second stream on the cathode side, wherein the second stream comprises water and provides a reducing environment for the cathode.

13. The system of claim 12, wherein the anode comprises Ni or NiO and a material selected from the group consisting of YSZ, CGO, SDC, SSZ, LSGM, and wherein the cathode comprises Ni or NiO and a material selected from the group consisting of YSZ, CGO, SDC, SSZ, LSGM, and combinations thereof.

14. The system of claim 12, wherein the membrane comprises CoCGO or LST (lanthanum-doped strontium titanate)-stabilized zirconia, wherein optionally LST comprises LCST (lanthanum-and-calcium-doped strontium titanate), wherein optionally the stabilized zirconia comprises YSZ or SSZ or SCZ (scandia-ceria-stabilized zirconia).

15. (canceled)

16. The system of claim 12, wherein the second stream comprises hydrogen.

17. The system of claim 12, wherein the mole ratio of ammonia to oxidant on the anode side is no less than 2, or no less than 3, or no less than 4.

18. The system of claim 12, wherein the anode is configured to receive a hydrocarbon.

19. The system of claim 12 comprising a multi-position injection port in fluid communication with the reactor, wherein the multi-position injection port is configured to introduce to the anode the oxidant, the hydrocarbon, or both.

20. The system of claim 12, wherein the cathode is configured to generate hydrogen from water electrochemically.

21. (canceled)

22. The system of claim 12, wherein the membrane comprises an electronically conducting phase containing doped lanthanum chromite or an electronically conductive metal or combination thereof; and wherein the membrane comprises an ionically conducting phase containing a material selected from the group consisting of gadolinium doped ceria (CGO), samarium doped ceria (SDC), yttria-stabilized zirconia (YSZ), lanthanum strontium gallate magnesite (LSGM), scandia-stabilized zirconia (SSZ), Sc and Ce doped zirconia, and combinations thereof, wherein optionally the doped lanthanum chromite comprises strontium doped lanthanum chromite, iron doped lanthanum chromite, strontium and iron doped lanthanum chromite, lanthanum calcium chromite, or combinations thereof; and wherein the conductive metal comprises Ni, Cu, Ag, Au, Pt, Rh, Co, Ru, or combinations thereof.

23. (canceled)

24. The system of claim 12, wherein the EC reactor comprises no interconnect and no current collector.
